(19) United States
(12) Patent Application Publication
(10) Pub. No.: US 2006/0259812 A1
(43) Pub. Date: Nov. 16, 2006

(54) Data protection method

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/205,628

(22) Filed: Aug. 16, 2005

(30) Foreign Application Priority Data
May 12, 2005 (TW) 094115338

(51) Int. Cl. G06F 11/00

(52) U.S. Cl. 714/6

(57) ABSTRACT

A data protection method applicable in a data storage system is proposed, so that data stored by a user in a plurality of memory units in the data storage system are prevented from being damaged due to damaged memory blocks in two of the memory units corresponding to each other. When reading data from a particular memory unit by a user is unsuccessful, the method reconstructs the data, rewrites the data into an undamaged memory block of the memory unit and delivers the data to the user. Thus, the method achieves the data protection purpose by allowing data to be read successfully through data reconstructing and rewriting, even when two corresponding memory blocks of storage units storing the same data are damaged.

### FIELD OF THE INVENTION

The present invention relates to a data protection method, and more particularly, to a data protection method applicable in data storage system.

### BACKGROUND OF THE INVENTION

Most of large database storage systems nowadays employ a format called RAID (Redundant Array of Independent Disks), which assembles many smaller disk drives to form a disk array in order to storage a large amount of data. The purpose of RAID is to store the same data in various different disks to improve performance of a storage sub-system, thereby providing greater yield and/or fault tolerance.

RAID achieves better performance by spreading workloads in parallel in many physical disk drives, that is, creating the multiplicity effect by accessing individual disks at the same time. When storing data, data are segmented into many data blocks and stored in respective disk drives of the disk array. When reading data, data are read from a plurality of disks simultaneously. Thus, data access speed is increased, enhancing the performance of the entire disk system.

Moreover, through parallel operations, in the event that one (or more) disk drive or disk sector has a problem, a backup of the data stored in the problematic disk drive (sector) can be found in another disk drive, thus obtaining better fault tolerance. That is, RAID has a plurality of level, each representing how data blocks are configured in a disk array. If a disk array stores data in a particular level, in the event that a disk in the disk array fails, the data block stored in that failed disk can be properly reconstructed based on the rest of working disks, thus increasing protection of data stored.

RAID has a plurality of level, each representing a different data protection level and storage capacity. Users may choose different RAID levels for setting the configuration format of the entire disk array according to their needs. Several common types of RAID levels are described below.

RAID 0 is where all disk drives in a disk array are considered as a single large disk, and the capacity thereof approximately equals to the capacity sum of all the disks (number of disks×minimum disk capacity). Data are distributed in any one of the disk drives of the disk array. Since data can be read and write in a parallel manner, the access efficiency of the disk array is better than a real single large disk. The access efficiency is proportional to the number of disk drives in the disk array. Normally, better performance can be realized when a large amount of sequential data (such as multimedia data) are accessed. However, RAID 0 does not have any fault tolerance ability. That is, if any one of the disk malfunctions, the entire disk array is affected.

RAID 1 is also known as disk mirroring. When data are written into a RAID 1 disk array, it will be written into each one of the disks. Thus, it would take all the disks to fail to loss the data. Compared to RAID 0, RAID 1 has better data protection but less data storage capacity. Thus, RAID 1 is usually used in environments where high data protection is demanded.

RAID 5 is similar to RAID 0 in that many smaller disk drives are regarded as one large disk drive. Additionally, redundancy information is stored as parity. While data are being written into the disk array, RAID 5 will also generate redundancy information based on the written data and store the information in the disk array. Parity is distributed in each of the disk drives, and the data volume of the parity is equivalent to the capacity of a disk drive. Since data and parity information are spread through out the disks of the disk array, if one disk drive fails, data stored in the failed disk drive can still be reconstructed based on the data and parity stored in other functioning disk drives. Simply, in order to ensure data protection, RAID 5 has to employ a volume equivalent to a disk drive to store redundancy information.

In summary, if a user wishes to choose a higher data protection level, he/she may choose a RAID 1 or RAID 5 configuration format. In reading data, if there is a malfunctioning (e.g. a bad sector), RAID 1 or RAID 5 can be employed to reconstruct data for the user, but according to the inherent restriction of RAID, only at most one disk drive is allowed to fail in order for data to be successfully reconstructed. When reading data, if one disk drive fails, then RAID 1 or RAID 5 will automatically reconstruct the data and deliver to the user. At this time, the bad disk drive is still in the malfunctioning status, and if another disk drive corresponding to the bad sector of the failed disk also generates a bad sector, data cannot be reconstructed, which causes permanent data damage.

Thus, there is need for a disk array that can make a backup of data in a bad sector of a disk drive and store it in another disk drive in order to successfully enable data accessing by the user in case of disks failing.

### SUMMARY OF THE INVENTION

In the light of forgoing drawbacks, an objective of the present invention is to provide a data protection method that allows users to read data successfully.

Another objective of the present invention is to provide a data protection method that prevents data stored in storage units from being damaged in the case of corresponding memory blocks of two storage units storing the same data are both damaged.

In accordance with the above and other objectives, the present invention discloses a data protection method. When reading data from a particular memory unit by a user is unsuccessful, the method reconstructs the data, rewrites the data into an undamaged memory block of the memory unit and delivers the data to the user.

Compared to the problems in the prior art, the present invention achieves the above objectives through data reconstructing and rewriting, even when two corresponding memory blocks of storage units storing the same data are damaged.

### BRIEF DESCRIPTION OF THE DRAWINGS

The present invention can be more fully understood by reading the following detailed description of the preferred embodiments, with reference made to the accompanying drawings, wherein:

FIG. 1 is schematic flow diagram indicating the implementing flow of basic steps of a preferred embodiment of the data protection method of the present invention; and

FIGS. 2(A) to 2(D) are schematic block diagrams showing data accessing operations of the preferred embodiment of the data protection method of the present invention.

### DETAILED DESCRIPTION OF THE EMBODIMENTS

The present invention is described in the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

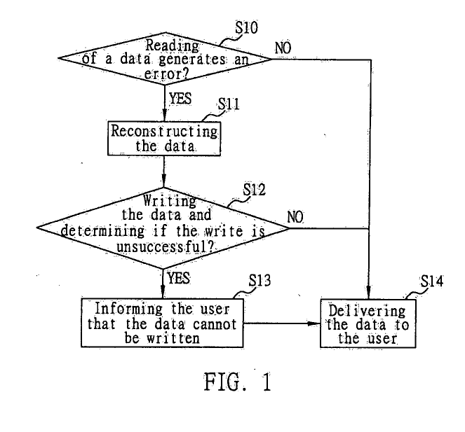

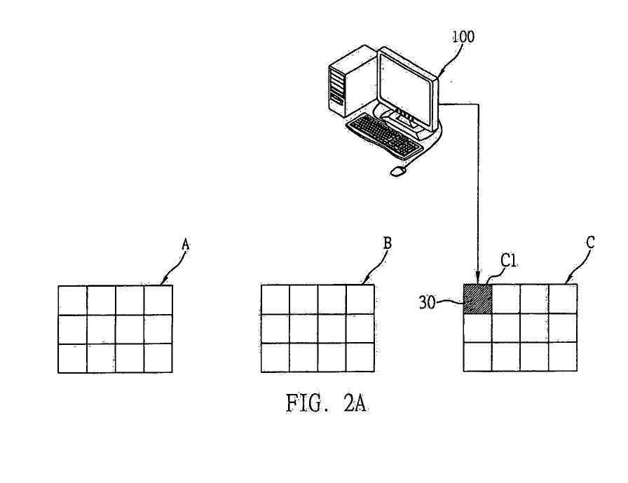

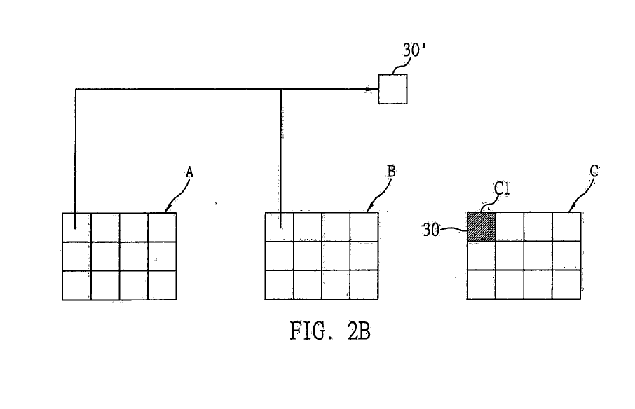

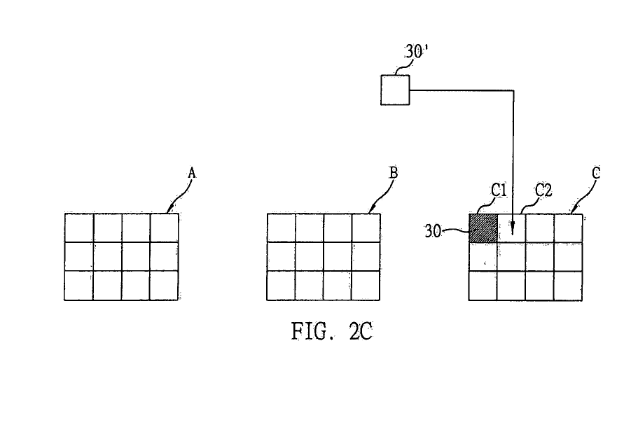

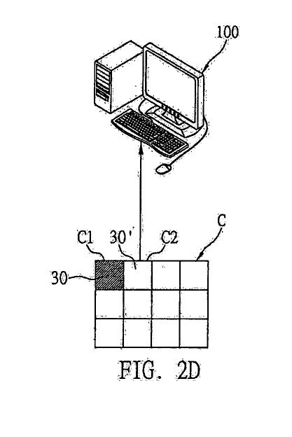

FIGS. 1, 2(A) to 2(D) show diagrams related to data protection method of the present invention. The preferred embodiments of the data protection method of the present invention will be described in conjunction with the drawings. It should be noted that the drawings herein are simplified schematic diagrams for illustrating the basic configurations of the present invention. The elements shown therein are not drawn to actual scales, numbers and shapes. The actual scales, numbers and shapes depend on actual designs and the layout of the elements may be more complicated.

The present invention discloses a data protection method, which is applicable in a data storage system, so that data stored by the user in a plurality of storage unit in the data storage system is prevented from being damaged due to damaged memory blocks in two storage units corresponding to each other. The preferred embodiments of the present invention are described in conjunction with the appended drawings.

FIG. 1 shows a flow chart of a preferred embodiment of the data protection method of the present invention, which represents the flow of basic implementation steps of the preferred embodiment. The embodiment is applicable in a disk system employing a disk array, so that data stored by the user in a plurality of disk drives in the disk system is prevented from being damaged due to damaged sectors in two of the disk drives corresponding to each other. The method firstly implements step S10.

Step S10 is used to determine whether reading of data generates an error. This step determines whether there is an error generated when reading data from a disk in a disk array. That is, the disk system determines if the data cannot be read out from the disk drive when a user tries to read data from a disk of the disk array. If so, then proceed to step S11, else, proceed to step S14. The disk array is a RAID (Redundant Array of Independent Disks), particularly, a RAID 1 or RAID 5. The functions provided by a RAID 1 or RAID 5 have already been discussed in the prior art, therefore will not be further described.

Step S11 is used to reconstruct the data. This step implements reconstruction of data by an internal mechanism of the disk array when reading data from one of the disks generates an error. That is, as shown FIG. 2(A), when data 30 cannot be read from a disk sector C1 of a disk C, then as shown in FIG. 2(B), data 30′ is reconstructed from other properly functioning disks A and B using mirroring or parity. Proceed to step S12.

Step S12 is used to write data and determine whether the write is successful. In conjunction with FIG. 2(C), after data 30′ is reconstructed, the data 30′ is written into an undamaged sector C2 of the disk C by a bad sector remapping provided by the disk C. If data 30′ cannot be written into the sector C2 of the disk C, proceed to step S13; else carry out step S14.

Step S13 is used to inform the user that data cannot be written. This step is entered when data cannot be rewritten into an undamaged sector of the disk. There are possibly two reasons such condition may occur. First reason is that there is no more sectors in the disk for writing new data, that is, the disk does not have any empty and properly functioning sector. The disk system outputs a message informing the user the reason for an unsuccessful write is due to unavailable disk space, in other words, the disk may be damaged or full. The second reason is that the disk system cannot implement the rewrite operation. The disk system then outputs a message informing the user that the reason for an unsuccessful write is due to unable to implement the rewrite operation. The rewrite operation herein refers bad sector remapping operation provided by the disk drive above. In other words, the disk drive either does not provide such function or that the function is faulty. Proceed to step S14.

Step S14 is used to deliver data to the user. Please referring to FIG. 2(D), this step delivers data of a functioning disk drive or the data 30′ reconstructed by the internal mechanism of disk array to a user 100 for subsequent processing.

As described in the descriptions above and the corresponding drawings, the technical features and implementation manner of the present invention can be more fully understood. The data protection method enables a user to read data successfully even when memory blocks (e.g. disk sectors) of two corresponding storage units (e.g. disk drives) fail by rewriting data into a new sector when a failed disk sector is detected. Moreover, the user can be informed of the reason for an unsuccessful rewrite operation, so the user can take appropriate process based on the message output by the data storage system (e.g. disk system), such as replacing with a new disk drive or one that provides bad sector remapping function.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A data protection method applicable in a data storage system, so that data stored by a user in a plurality of storage unit in the data storage system are prevented from being damaged due to damaged memory blocks in two of the storage units corresponding to each other, the method comprising the following steps of:
when reading a data from one of the storage units failed, reconstructing the data, rewriting the data into an undamaged memory block of said storage unit and delivering the reconstructed data to the user.

2. The data protection method as claimed in claim 1, wherein the data storage system employs a disk array.

3. The data protection method as claimed in claim 2, wherein the reading of a data includes reading a data from the data storage system under the circumstance of the disk array.

4. The data protection method as claimed in claim 2, wherein the reconstructing of the data is achieved by the disk array.

5. The data protection method as claimed in claim 2, wherein the disk array is a Redundant Array of Independent Disks (RAID).

6. The data protection method as claimed in claim 5, wherein the RAID is one of a RAID 1 or a RAID 5.

7. The data protection method as claimed in claim 1, wherein the rewriting of the data is obtained by a bad sector remapping function.

8. The data protection method as claimed in claim 7, wherein the bad sector remapping function is provided by the storage unit.

9. The data protection method as claimed in claim 1 or 2 or 3, wherein the data storage system is a disk system.

10. The data protection method as claimed in claim 1, wherein the storage units are disks.

11. The data protection method as claimed in claim 10, wherein the memory block is a sector of the disk.

12. The data protection method as claimed in claim 1, wherein if the data cannot be rewritten into the undamaged memory block of the storage unit, indicating that the storage unit has no available memory block for storage, the data storage system outputs a message informing the user that the storage unit is unavailable for the rewrite process and delivers the data to the user.

13. The data protection method as claimed in claim 1, wherein if the data cannot be rewritten into the undamaged memory block of the storage unit, indicating that the rewrite function of the data storage system is unavailable, the data storage system outputs a message informing the user that the rewrite function of the data storage system is unavailable and delivers the data to the user.

14. The data protection method as claimed in claim 13, wherein the rewrite function is a bad sector remapping function.

15. The data protection method as claimed in claim 14, wherein the bad sector remapping function is provided by the data storage unit.

16. A data protection method applicable in a disk system employing a disk array, so that data stored by a user in a plurality of disks in the disk system are prevented from being damaged due to damaged sectors in two of the disks corresponding to each other, the method comprising the following steps of:
(1) determining whether an error is generated for reading one of the data from one of the disks in the disk array, if so, proceed to step (2); else proceed to step (5);
(2) reconstructing the data by the disk array;
(3) writing the data into the disk currently being read and determining whether the write is unsuccessful, if so, proceed to step (4); else proceed to step (5);
(4) informing the user that data cannot be written; and
(5) delivering the data to the user.

17. The data protection method as claimed in claim 16, wherein the disk array is a Redundant Array of Independent Disks (RAID).

18. The data protection method as claimed in claim 17, wherein the RAID is one of a RAID 1 or a RAID 5.

19. The data protection method as claimed in claim 16, wherein the rewriting of the data is obtained by a bad sector remapping function.

20. The data protection method as claimed in claim 19, wherein the bad sector remapping function is provided by the storage unit.

21. The data protection method as claimed in claim 16, wherein the writing of data includes writing data into an undamaged sector of the disk.

22. The data protection method as claimed in claim 21, wherein if the data cannot be rewritten into the undamaged memory block of the storage unit, indicating that the storage unit has no available memory block for storage, the data storage system outputs a message informing the user that the storage unit is unavailable for the rewrite process and delivers the data to the user.

23. The data protection method as claimed in claim 21, wherein if the data cannot be rewritten into the undamaged memory block of the storage unit, indicating that the rewrite function of the data storage system is unavailable, the data storage system outputs a message informing the user that the rewrite function of the data storage system is unavailable and delivers the data to the user.

24. The data protection method as claimed in claim 23, wherein the rewrite function is a bad sector remapping function.

25. The data protection method as claimed in claim 24, wherein the bad sector remapping function is provided by the disk.
